(19) United States
(12) Patent Application Publication
(10) Pub. No.: US 2008/0092990 A1
(43) Pub. Date: Apr. 24, 2008

(54) Manufacturing of Wooden Rod with Central Hollow

(76) Inventor: Steven TSAI, Taichung City (TW)

Correspondence Address: SINORICA, LLC, 528 FALLSGROVE DRIVE, ROCKVILLE, MD, 20850, US

(21) Appl. No.: 11/772,276

(22) Filed: Jul. 2, 2007

(30) Foreign Application Priority Data
Jun. 30, 2006 (TW) 095124022

(51) Int. Cl. B27M 3/22; B27N 5/02

(52) U.S. Cl. 144/365

(57) ABSTRACT

A manufacturing method of wooden rod with central hollow. The manufacturing method includes steps of: preparing a wooden material with a predetermined length and a predetermined minimum outer diameter; axially drilling the wooden material from one end to the other end to form a shaft hole; fitting a reinforcing material into the shaft hole; and locating the wooden material with an axis of the shaft hole as a rotary axis and milling a periphery of the wooden material to form a rod/bat body with a predetermined shape.

### BACKGROUND OF THE INVENTION

The present invention is related to a processing method for wooden rod/bat, and more particularly to a manufacturing method of wooden rod with central hollow.

This applicant previously disclosed a wooden rod/bat with central hollow, which is applicable to a cue or a baseball bat. In order to reinforce such rod/bat with natures of wood, a hollow with a certain depth or a through passage is axially formed in the wooden rod/bat along the curvature central axis thereof. In addition, a reinforcing material with better strength, such as a tubular complex material, is coaxially accommodated in the hollow to provide an internal strengthening effect for the wooden rod/bat body. When used as a baseball bat, the reinforcing material is able to increase the bearing strength of the wooden bat when striking a ball. Also, the reinforcing material serves to prolong the using life of the wooden bat. In the case that the wooden rod is used as a cue, the reinforcing material provides an axial support to offset the unevenness of hardness caused by irregular grains of the wooden material. Accordingly, the problem of axial inaccuracy of the shot can be obviated.

The above structure is able to widen the application range of the wooden material. However, there is still no optimal manufacturing method which can be used to more efficiently manufacture the wooden rod with central hollow. It is therefore tried by the applicant to provide a manufacturing method for mass-producing such wooden rod/bat with central hollow.

### SUMMARY OF THE INVENTION

It is therefore a primary object of the present invention to provide a manufacturing method of wooden rod with central hollow. By means of this manufacturing method, the wooden rod product can be made more easily and the quality of the wooden rod product can be ensured.

According to the above object, the manufacturing method of wooden rod with central hollow of the present invention includes steps of: preparing a wooden material with a predetermined length and minimum outer diameter; axially drilling the wooden material from one end to the other end to form a linearly extending shaft hole; coaxially fixedly fitting a reinforcing material into the shaft hole; and locating the wooden material with an axis of the shaft hole as a rotary axis and milling a periphery of the wooden material to form a rod body with a predetermined shape.

The present invention can be best understood through the following description and accompanying drawings wherein:

### BRIEF DESCRIPTION OF THE DRAWINGS

FIG. 1 is a flow chart of a first embodiment of the manufacturing method of the present invention; and

FIG. 2 is a flow chart of a second embodiment of the manufacturing method of the present invention.

### DETAILED DESCRIPTION OF THE PREFERRED EMBODIMENTS

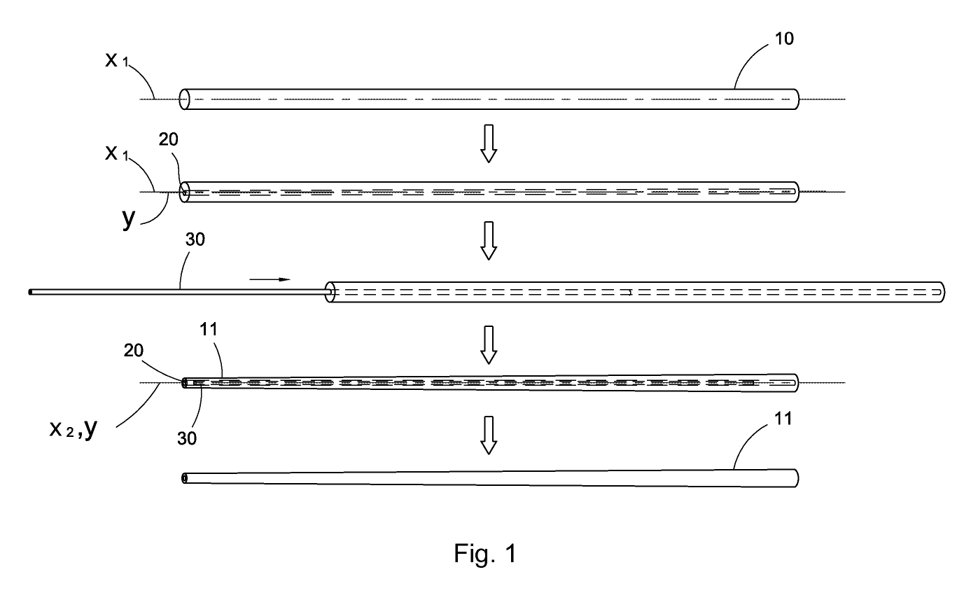

Please refer to FIG. 1. The manufacturing of wooden rod with central hollow according to a first embodiment of the present invention includes steps of:
a. preparing a wooden material 10 in form of straight rod, the wooden material 10 having a certain length and a certain minimum outer diameter, the cross-section of the wooden material 10 being not limited to circular shape;
b. axially drilling the wooden material 10 from one end to the other end to form a linearly extending shaft hole 20 with a certain diameter;
c. preparing a tubular complex reinforcing material 30 with a length shorter than the length of the shaft hole 20, the reinforcing material 30 being coaxially fixedly accommodated in the shaft hole 20, two ends of the reinforcing material 30 being respectively spaced from two openings of two ends of the shaft hole 20 by a certain distance; and
d. locating the wooden material 10 with an axis of the shaft hole 20 as a rotary axis of the wooden material 10, a periphery of the wooden material 10 being milled to form a tapered rod body 11 as a shaft of a cue.

It should be noted that in the above manufacturing, the axis of the shaft hole 20 serves as the center of the wooden rod. In step b, even if the axis y of the shaft hole 20 does not coincide with the curvature center x₁ of the wooden material in step a or fail to deflect from the curvature center x₁ within an allowable error range, by means of step d, the axis y of the shaft hole 20 will eventually coincide with the curvature center x₂ of the tapered rod body 11 within an allowable error range. Accordingly, the tapered wooden rod body 11 with internal reinforcing structure can be made by means of an easier method. The wooden rod body 11 is applicable to a sport implement.

In addition, there are two things which should be further noted as follows:

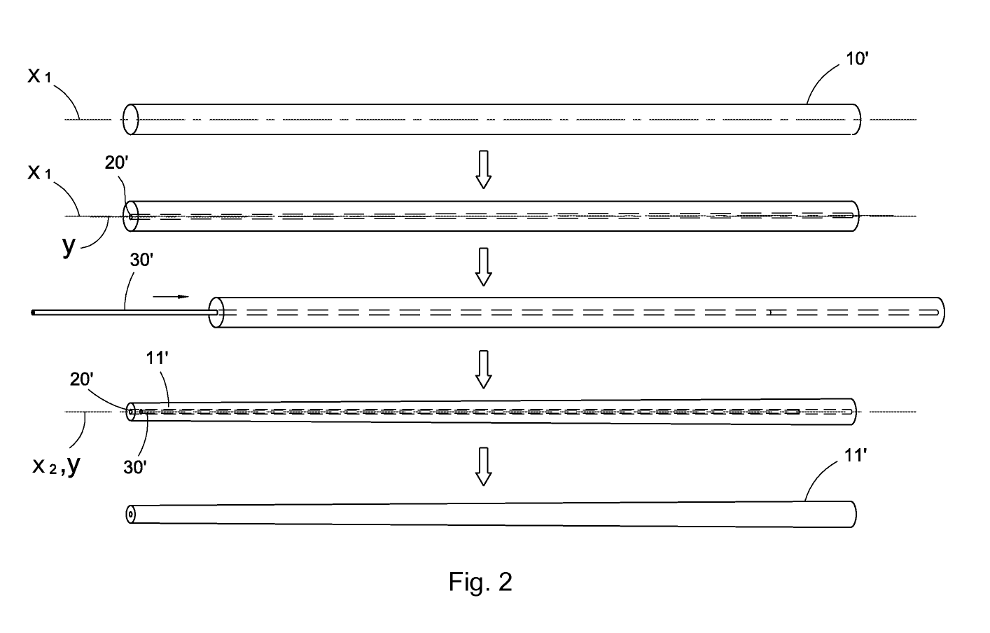

First, in step a, the minimum outer diameter of the wooden material 10 is preferably larger than the maximum outer diameter of the wooden rod body 11 in step d. Otherwise, there will be nothing to mill in step d and it is necessary to add material to the wooden material 10 and shape the same into the wooden rod body 11. However, the shaping procedure is equivalent to the milling procedure. Moreover, in step d, the rod body 11 is not limited to the shaft of the cue. As shown in FIG. 2, according to a second embodiment of the present invention, the wooden material 10 can be milled to form a butt of a cue, a baseball bat or any other rod-shaped/bat-shaped sport implement.

Second, in the above embodiment, the reinforcing material 30 is a complex tubular material. However, the reinforcing material 30 is not limited to the complex tubular material. In practice, the natures of the reinforcing material can be changed, depending on the requirement of the wooden rod body. Instead of rigid reinforcing material, an elastic reinforcing material can be also applied to the wooden rod body. For example, a foam material can be filled into the shaft hole to serve as the elastic reinforcing material. In other words, the reinforcing material 30 is not limited to rigid material. Elastic material or other material is also applicable to the wooden rod body.

The above embodiments are only used to illustrate the present invention, not intended to limit the scope thereof. Many modifications of the above embodiments can be made without departing from the spirit of the present invention.

What is claimed is:

1. A manufacturing method of wooden rod with central hollow, comprising steps of:
a. preparing a wooden material with a predetermined length and a predetermined minimum outer diameter;
b. axially drilling the wooden material from one end to the other end to form a shaft hole with a predetermined diameter; and
c. locating the wooden material with an axis of the shaft hole as a rotary axis and processing a periphery of the wooden material to form a rod/bat body with a predetermined shape.

2. The manufacturing method of wooden rod with central hollow as claimed in claim 1, wherein in step a, the minimum outer diameter of the wooden material is larger than a maximum outer diameter of the rod/bat body in step c.

3. The manufacturing method of wooden rod with central hollow as claimed in claim 1, wherein in step b, the axis of the shaft hole is unnecessary to coincide with or parallel to the axis of the wooden material.

4. The manufacturing method of wooden rod with central hollow as claimed in claim 1, wherein in step c, the wooden material is milled into a baseball bat shape.

5. The manufacturing method of wooden rod with central hollow as claimed in claim 1, wherein in step c, the wooden material is milled into a section of a cue.

6. The manufacturing method of wooden rod with central hollow as claimed in claim 5, wherein the wooden material is milled into a shaft of a cue.

7. The manufacturing method of wooden rod with central hollow as claimed in claim 5, wherein the wooden material is milled into a butt of a cue.

8. The manufacturing method of wooden rod with central hollow as claimed in claim 1, wherein a reinforcing material is disposed in the shaft hole.

9. The manufacturing method of wooden rod with central hollow as claimed in claim 8, wherein the reinforcing material is a tubular material having an outer diameter approximately equal to the diameter of the shaft hole, the reinforcing material having a length shorter than the length of the shaft hole, the tubular reinforcing material being coaxially accommodated in the shaft hole.

10. The manufacturing method of wooden rod with central hollow as claimed in claim 9, wherein the reinforcing material is a tubular complex material.
